(19) United States
(12) Patent Application Publication
(10) Pub. No.: US 2008/0244559 A1
(43) Pub. Date: Oct. 2, 2008

(54) Acquisition and Control System

(76) Inventors: Yutaka Imasato, Kanagawa-Ken (JP); Francis Alvarez, Clamart CEDEX (FR); Josiane Magnoux, Houston, TX (US)

Correspondence Address: Victor H Segura;Schlumberger Technology Corporation, 200 Gillingham Lane, Sugar Land, TX, 77478, US

(21) Appl. No.: 10/553,047

(22) PCT Filed: Apr. 7, 2004
(86) PCT No.: PCT/EP2004/003776

§ 371 Date: Jun. 6, 2006

(30) Foreign Application Priority Data
Apr. 16, 2003 (GB) 0308784.4

(51) Int. Cl. G06F 9/445

(52) U.S. Cl. 717/174

(57) ABSTRACT

An acquisition and control system for use with devices installed in an underground well, comprising: an installation designer, a data server including a database of device specific and installation-specific data; an application builder; and a control and acquisition system; wherein the installation designer comprises a system for defining a hardware and software functional configuration for the devices installed in the well, the functional configuration being provided to the data server; the application builder comprises a system for obtaining software components from the data server and configuring such components to correspond to the functional configuration defined by the installation builder, the application builder outputting the configured software components to the control and acquisition system; and the control and acquisition system installs the configured software components in a data communication and processing environment connected to the devices installed in the well so as to control operation of the devices and to acquire data from the devices in accordance with the functional configuration.

The present invention relates to acquisition and control systems for use with devices installed in underground well, such as oil or gas wells. In particular, the invention relates to such systems that can be easily configured according to the particular arrangement of devices and functionality in a given well.

When a well such as an oil well is completed for production, it is common to install devices such as sensors, valves, pumps, etc. for the purpose of monitoring and controlling the production of fluids from the well. These devices are monitored and controlled from the surface (the well-head, which may be on the sea bed in an offshore location) by a suitable control system. There are a number of commercially available platforms for such control systems, known as “Supervisory Control and Data Acquisition Systems” or “SCADAs”. Typically, when devices are installed in a well, a corresponding SCADA application is created and is installed on a computer at or near the well head and connected to the devices in the well. Each update or addition of new functionality requires a new release of the SCADA application and its installation in the particular well system. As each SCADA application is specific to each well, the job of maintaining the applications in a field of many wells becomes correspondingly large with updates, modifications or additions of functionality. For various reasons it may be desirable to change the way a SCADA apparatus is programmed at well site to behave and respond to the data it receives and operates on and, in previous systems, each time this must be done it is necessary to customize the SCADA apparatus in such a way that the result becomes so much specific that it is almost impossible to reuse it. To deal with this, the present invention proposes that the SCADA apparatus system uses a modular collaborative workspace architecture consisting of a framework providing the overall application resources, and modules providing device specific components; the framework hosts the modules, and the modules are defined in the installation designer apparatus and realized by application builder engine.

It is an object of the present invention to provide a system which allows relatively easy installation and updating of the acquisition and control functions without the need to completely rebuild and re-install the system each time a change is made.

In accordance with the present invention, there is provided an acquisition and control system for use with devices installed in an underground well, comprising:

an installation designer;

a data server including a database of device-specific and installation-specific data;

an application builder; and

a control and acquisition system; wherein

the installation designer comprises a system for defining a hardware and software functional configuration for the devices installed in the well, the functional configuration being provided to the data server;

the application builder comprises a system for obtaining software components from the data server and configuring such components to correspond to the functional configuration specified by the installation designer, the application builder outputting the configured software components to the control and acquisition system; and

the control and acquisition system installs the configured software components in a data communication and processing environment connected to the devices installed in the well so as to control operation of the devices and to acquire data from the devices in accordance with the functional configuration.

The installation designer is a software environment that allow a user to compose software modules based on data obtained from the database via the data server in terms of the function required for the installation. It reads and displays data from the data server in order to define the modules. The definition of a module can occur in three ways. In adding a module, the installation builder takes functional data from the server and creates a new module based on the specific arrangement of the data. In modifying a module, the data of an module existing in the data server are changed. In deleting a module, the data defining a module are deleted from the data server.

The application builder is a software engine which realizessoftware resources to fulfill the functional requirements of the software modules defined by the installation designer and provides them in the defined functional configuration. Both the software resources and the functional configuration are obtained from the database via the data server. The output of the application builder is control and acquisition software to be installed in the data communication and processing environment connected to the devices installed in the well.

Using this invention SCADA apparatus at well site are reproducible in various environments, reduces significantly the design time, allows faster and simpler SCADA apparatus upgrades and maintenance providing finally seamless integration which greatly increasing productivity.

The present invention will now be described in relation to the accompanying drawings, in which:

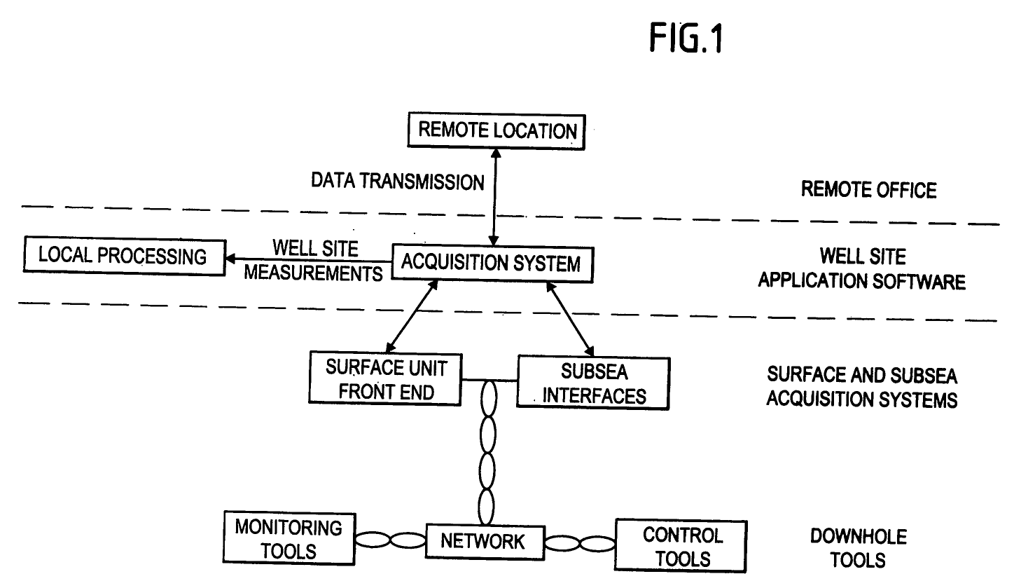

FIG. 1 shows a schematic diagram of the application of the system of the invention;

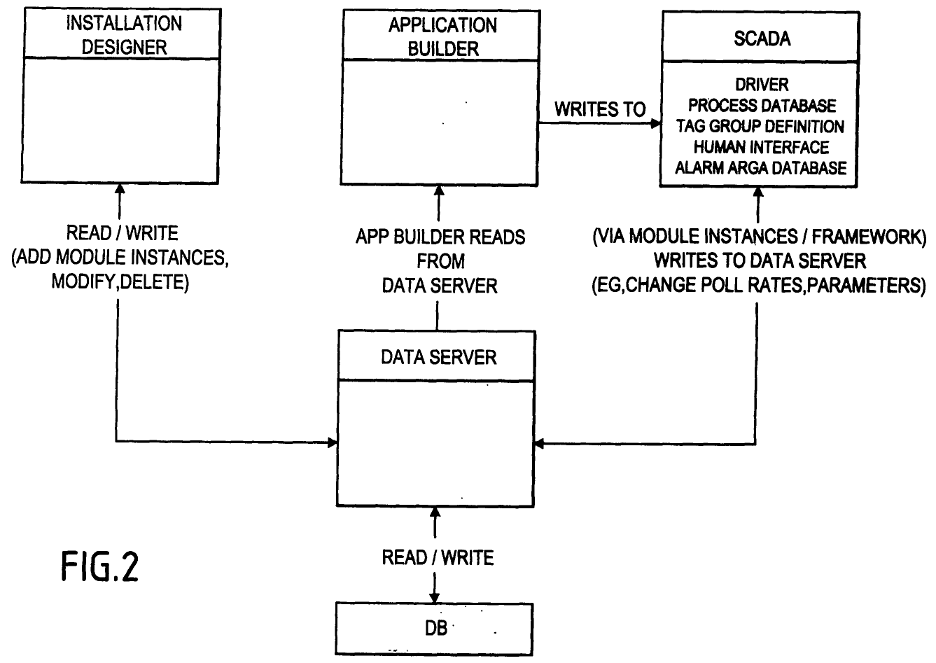

FIG. 2 shows the basic structure and data flow of the system according to the invention;

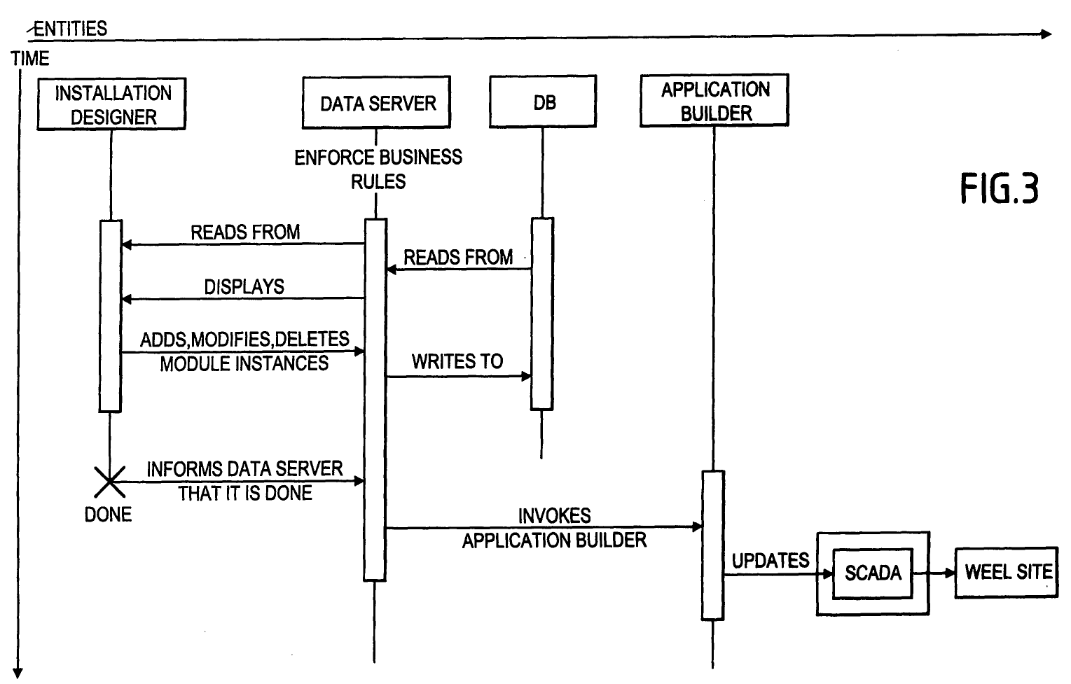

FIG. 3 shows a sequence diagram for full application building;

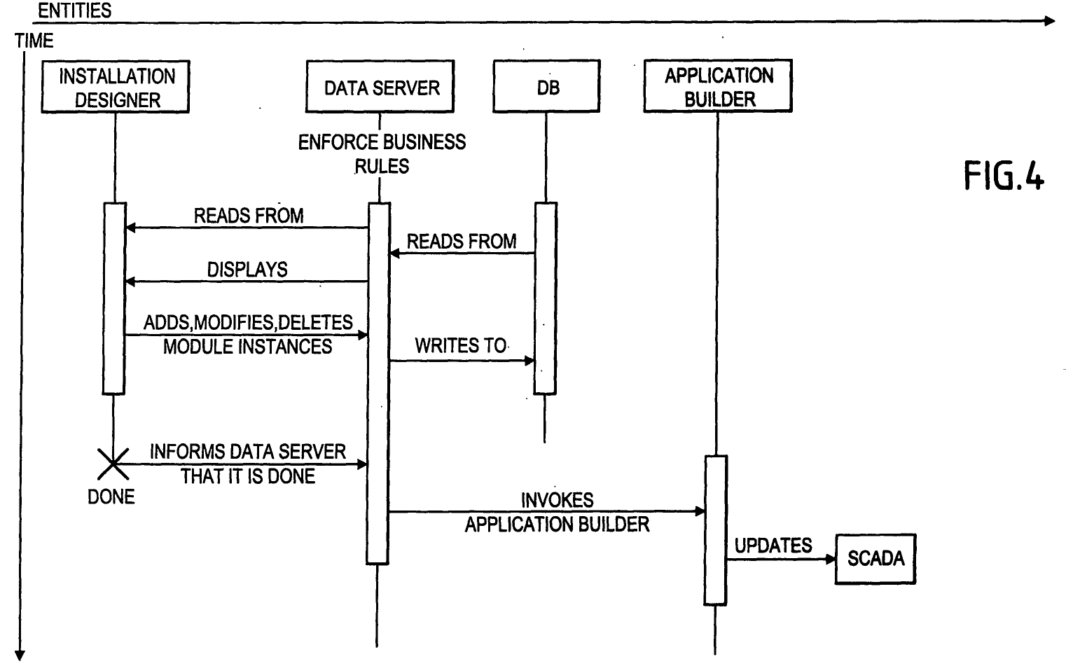

FIG. 4 shows a sequence diagram for runtime application building;

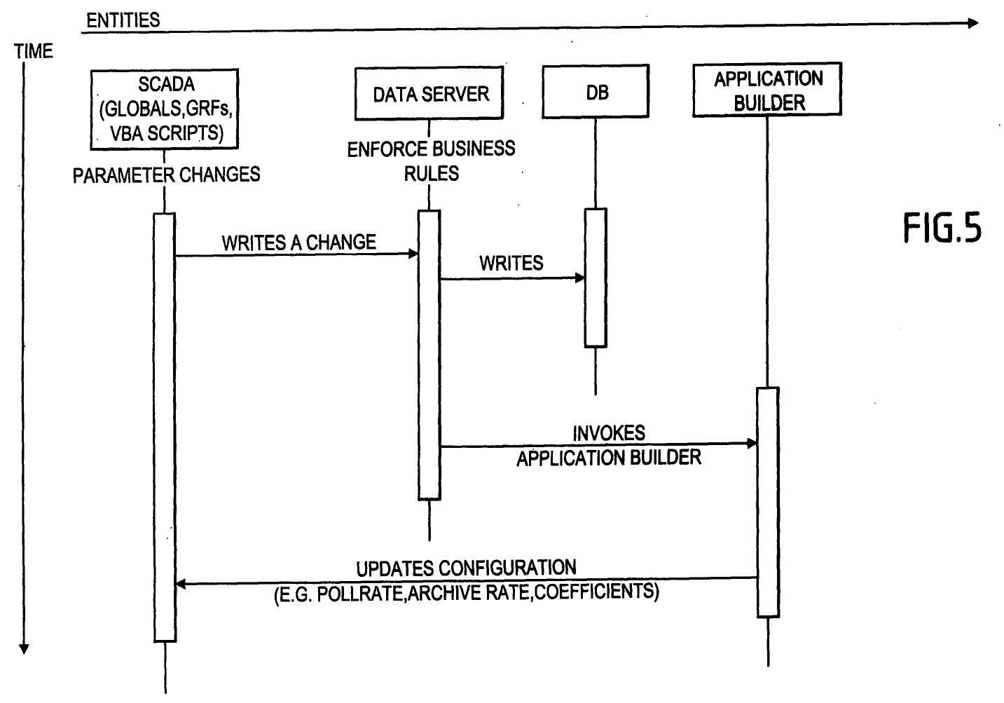

FIG. 5 shows a sequence diagram for runtime parameter changes;

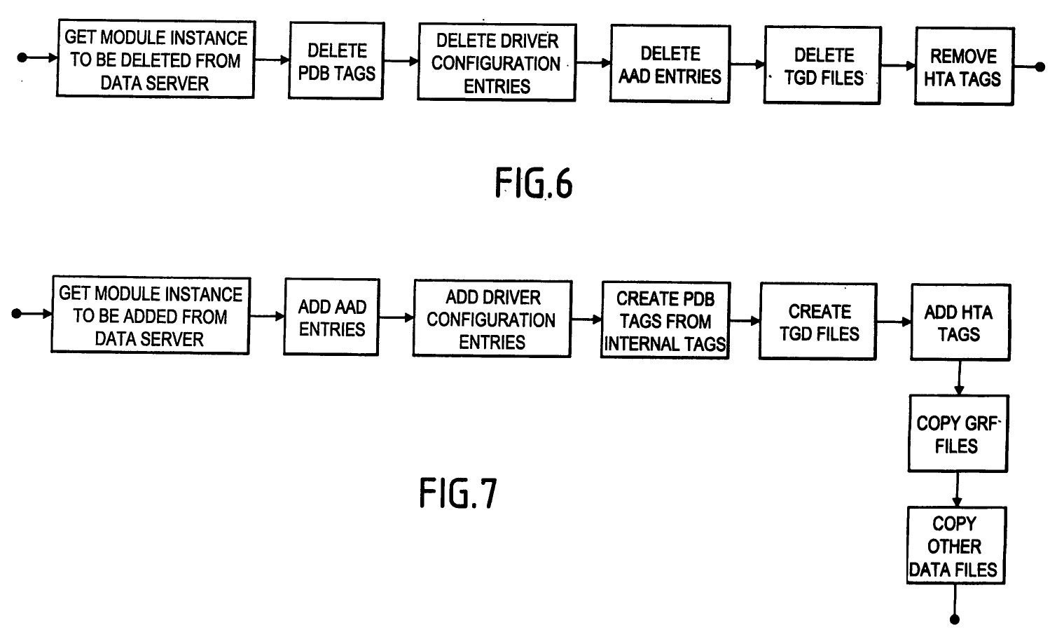

FIG. 6 shows a delete module activity diagram;

FIG. 7 shows an add module activity diagram; and

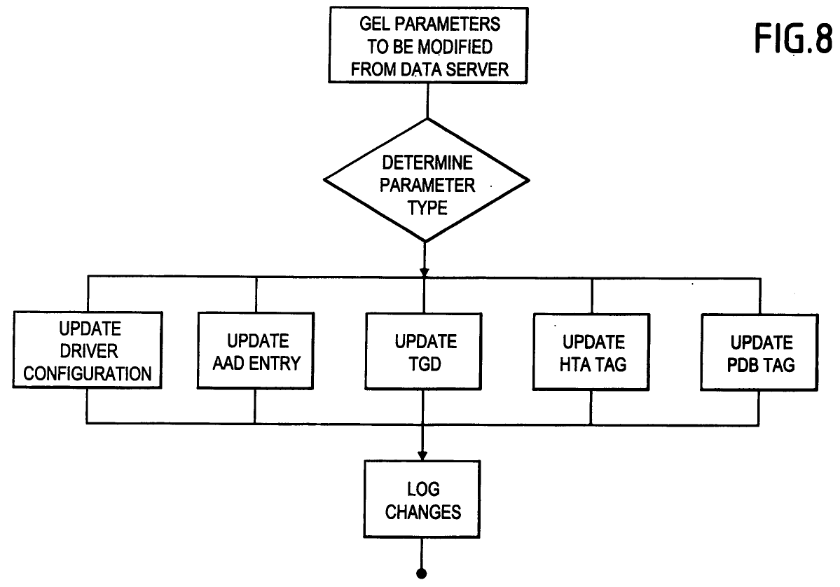

FIG. 8 shows a modify module instance parameter activity diagram.

The basic environment of the invention is shown schematically in FIG. 1. Each well has a number of devices installed for the purpose of controlling the production of fluids from the well. These devices can include control tools such as valves, and monitoring tools such as pressure, temperature and density measuring devices, water cut meters and flow meters, or resistivity measurement arrays. These devices are typically connected to a data and power network such as the Wellnet system of Schlumberger. The network extends along the well to the surface where it is connected to a surface and subsea acquisition system comprising a surface unit front end device and, when appropriate, subsea interfaces. The acquisition system is connected to a well-site system, typically located at or near the well for operator use. This allows data to be viewed and extracted for processing locally, and for further communication, and for control of the system in operation. It is at this point that the software for monitoring and controlling the hardware devices is located. The data can be further communicated to a remote location for further processing and analysis.

The basic structure of the system according to the invention together with general data flow indications is shown in FIG. 2, and comprises a data server and associated database, an installation designer, an application builder and a SCADA. The database includes a basic software framework which comprises the elements, screens and tasks common to any application in the SCADA (e.g. navigation, data storage, reports, units, alarm management), together with specific software modules related to the operation of the various devices that may be installed in the well, and existing functional configurations and SCADA applications that may have been created previously.

The software framework provides the structural support of an application. The software framework exists as a set of elements, screens, or tasks that are common to all applications yet customized according to the specific hardware installation created in the installation designer according to the predefined well installation. The software framework provides through its interface a standard navigation rationale from which modules, developed during the design stage, are called. There is only one framework per application. The software framework hosts basic functionalities such as:
Secure acquisition and control,
Real time database (polled and computed data),
Alarm management,
Data history,
OLE for Process Control (OPC) connectivity, an industry standard TCP/IP based process data communication protocol,
Graphical Human Interface

In addition to these basic software framework services, extended software services can include:
Data Server, an automated server that runs as a background service.
Database, managed by the Data Server for all data transactions.
A dedicated ActiveX component for Windows Explorer-like navigation of the current installation.

(The data server and database functions are present in a number of aspects of the system according to the invention.)

The system architecture delegates to the module the responsibility to perform product specific tasks as determined in the job planning stage. Each module is a set of software resources, with a specific focus on a particular device, calculation, or object. A module is a computer-oriented representation of the job planning description and is made from a module definition format and module definition resources. In the final application the software framework hosts both the module definition format and the module definition resources.

The module definition format exists as a standard or generic definition containing all class and default information (e.g., data I/O, data chaining, and graphics display) necessary for the creation of a product-specific example in that class. These module definitions are provided when the particular product in question is developed Later, users of the present system input the well site and device specific parameters, obtained through the job planning requirements, to create a specific example of the module for the deliverable application.

Module definition resources include pre-built software resources such as animated and scripted graphics files, help files, application wizards, and other standard resources (e.g., I/O drivers, scheduling scripts).

Various different kinds of modules are recognized:
Tool/Application Modules (providing dedicated services or tasks: hardware, monitoring, data processing, monitoring and control),
Common Modules (providing basic services),
General Purpose Modules (mainly generic displays provided by the framework).

All of these modules are dedicated to perform specific tasks, but they do not have knowledge of each other. If a module needs. information of any kind, it sends a request to the software framework.

The installation designer provides an environment to create a software application specific to a particular well installation and to compose specific software modules within this framework. It describes in real-time acquisition and control terms the hardware and software installation corresponding to the devices installed (or to be installed) in the well in question. The installation tool comprises editors that allow specification of, for example:
hardware components (e.g. acquisition units, downhole tools);
data processing (e.g. flow computations from pressure measurements);
system properties to be monitored;
system components/properties to be controlled;
reservoir properties to be visualized;
predefined contents and formats of digital output (e.g. channels, units, sampling rate).

The output of the installation designer is a functional configuration of the SCADA software (framework and modules) required for a given well installation. This resides in the database and is accessed via the data server.

The application builder is a background task capable of either generating an entire application or updating an existing one. It automatically integrates the library resources into the software framework to accommodate the platform and, thus, unites the hardware and software descriptions of the installation.

The application builder produces the final application based on: module definition formats, module definition resources, common modules, and the software framework. The application builder can be run at a location remote from the well site to generate an application for testing purposes; however, each unique application is provided at the well site. The application builder is structured as a dynamic link library (DLL) and is invoked by the data server whenever a change to the SCADA application is required.

Both the installation designer and the application builder can be programmed using conventional techniques and languages, such as VC++.

FIGS. 3-5 show sequence diagrams of the system for full application building, runtime application building and runtime application parameter changes. As can be seen in the last case, the parameter changes are created in the SCADA application environment itself and communication is via the data server to the application builder only, there being no role for the installation designer in this case.

The application builder synchronizes the SCADA application with the current information in the database. This is done through a variety of calls, typically automation interfaces and exposed DLL's. The application builder extracts module definition information from the database via the data server and then realizes the application accordingly. The application areas that are typically updated are:
Driver Configuration
Process Database
Tag Group Definition
Historical Configuration
   Alarm Areas Database)

Obviously, the areas updated will depend on the particular structure of the application.

Module instances may be added, deleted, or modified. FIGS. 6-8 show the activity in each case. For deletion (see FIG. 6), Process Database tags are typically deleted first in order to prevent process alarms from being generated unnecessarily, followed by driver configuration, Alarm Areas Database entries, Tag Group Definition files and finally Historical Configuration tags. For addition (see FIG. 7), Alarm Areas Database entries are added first, then driver configuration, Process Database tags, Tag Group Definition files, Historical Configuration tags, human interface files, and finally other data files. For modification (see FIG. 8), the application builder obtains parameters to be modified from the data server and updates the appropriate areas and logs the changes.

The application builder requests driver configuration data for the particular module instance from the data server via provided data server object-based interfaces. It takes this information and utilizes the OLE automation interfaces in order to update the driver configuration.

The following operations are available for driver channels:
Delete Channels—Given a channel name, finds the corresponding channel object and deletes it; checks for errors; logs the change.
Add Channels—Adds a new channel; checks for errors; logs the change.
Modify Channels—Given a channel name, finds the corresponding channel object and modifies the parameters checks for errors; logs the change.

For each operation, the channel is disabled and then re-enabled in order for changes to be committed. All devices and datablocks which are children of this channel are also automatically disabled and re-enabled.

The same basic operations are also available for driver devices, driver datablocks, and other files and information as set forth below.

The application builder requests process database tag information from the data server. It reads that information and generate Process Database tags using a SCADA DLL interface. Tags may be Added, Deleted or Modified in the Process Database.

The application builder requests tag group information from the data server and uses a tag group automation interface in order to update the Tag Group Definition configuration.

The tag group file sets up alias names for tags, and places the aliases in a file so that when a picture is opened with this file it looks up the actual tag name using the alias that it has been given. By switching the tag group file for a screen at run time, multiple module instances can display their data in the same graphical representation.

The application builder requests historical archive information from the data server and uses the Historical Configuration automation interface in order to update the Historical Configuration configuration.

The application builder request alarm area information from the data server and uses exposed AAD DLL calls in order to update the AAD.

Thus it will be appreciated that the application builder can use these functions, together with other such functions common in the field of object oriented programming to create the final application software which can be installed at the well site.

1. An acquisition and control system for use with devices installed in an underground well, comprising:
an installation designer;
a data server including a database of device-specific and installation-specific data;
an application builder; and
a control and acquisition system;
wherein
the installation designer comprises a system for defining a hardware and software functional configuration for the devices installed in the well, the functional configuration being provided to the data server;
the application builder comprises a system for obtaining software components from the data server and configuring such components to correspond to the functional configuration defined by the installation designer, the application builder outputting the configured software components to the control and acquisition system; and
the control and acquisition system installs the configured software components in a data communication and processing environment connected to the devices installed in the well so as to control operation of the devices and to acquire data from the devices in accordance with the functional configuration.

2. The system as claimed in claim 1; wherein the installation designer defines the hardware and software configuration in the form of software modules based on data obtained form the database.

3. The system as claimed in claim 2, wherein the installation designer adds, modifies or deletes the modules.

4. The system as claimed in claim 2, wherein the application builder selects software resources from the database to fulfill the functional requirements of each module.

5. The system as claimed in claim 1, wherein the installation designer and application builder operate at a location remote from the well site.

6. The system as claimed in claim 5, wherein the output from the application designer is provided for installation at the well site.
